(19) United States
(12) Patent Application Publication
(10) Pub. No.: US 2024/0393156 A1
(43) Pub. Date: Nov. 28, 2024

(54) INDUSTRIAL SENSOR MODULE, MAINTENANCE ASSEMBLY, FLUIDIC SYSTEM AND PROCESS

(71) Applicant: Festo SE & Co. KG, Esslingen (DE)

(72) Inventors: Dietmar WAGNER, Esslingen (DE); Jürgen HÖRZ, Tübingen (DE); Markus HESSE, Ebersbach (DE); Dmitry ULANOV, Neckartenzlingen (DE)

(21) Appl. No.: 18/670,235

(22) Filed: May 21, 2024

(30) Foreign Application Priority Data
May 24, 2023 (DE) 10 2023 113 548.1

(51) Int. Cl. G01F 15/00

(52) U.S. Cl. CPC G01F 15/00

(57) ABSTRACT

An industrial sensor module, in particular for use in a maintenance assembly for the pressurized fluid treatment of a fluidic system. The sensor module includes a module housing, a pressurized fluid inlet arranged on the module housing, a pressurized fluid channel arranged in the module housing and a pressurized fluid outlet arranged on the module housing and fluidically connected to the pressurized fluid inlet via the pressurized fluid channel, and a sensor device arranged in the module housing with a flow sensor for detecting a pressurized fluid flow from the pressurized fluid inlet to the pressurized fluid outlet in order to provide one or more flow values. The sensor module further includes a computing unit arranged in the module housing, which is designed to provide at least one diagnostic function for generating diagnostic information on the basis of the one or more flow values.

This application claims priority to German Patent Application No. 10 2023 113 548.1 filed May 24, 2023, which is incorporated by reference.

### SUMMARY OF THE INVENTION

The invention relates to an industrial sensor module, in particular for use in a maintenance assembly for the pressurized fluid treatment of a fluidic system, wherein the sensor module comprises a module housing, a pressurized fluid inlet arranged on the module housing, a pressurized fluid channel arranged in the module housing and a pressurized fluid outlet fluidically connected to the pressurized fluid inlet via the pressurized fluid channel, and a sensor device arranged in the module housing with a flow sensor for detecting a pressurized fluid flow from the pressurized fluid inlet to the pressurized fluid outlet in order to provide one or more flow values. The pressurized fluid is preferably a gaseous pressurized fluid, preferably compressed air, argon, CO2, N2, forming gas, helium or oxygen. The pressurized fluid is in particular pressurized air. If the term “pressurized fluid” is used in the following, this refers in particular to “pressurized air”. If the term “fluidic” is used in the following, this refers in particular to “pneumatic”. The term “flow” preferably refers to “flow rate”. The term “pressurized fluid treatment of a fluidic system” in particular means the treatment of pressurized fluid of a fluidic system.

One object of the invention is to provide an improved industrial sensor module.

The object is solved by an industrial sensor module according to claim 1. The industrial sensor module comprises a computing unit arranged in the module housing, wherein the computing unit is configured to provide at least one diagnostic function for generating diagnostic information on the basis of the one or more flow values.

Advantageous further developments are the subject of the subclaims.

The invention further relates to a maintenance assembly for pressurized fluid treatment of a fluidic system, comprising the industrial sensor module and a functional unit fluidically connected to the industrial sensor module, wherein the functional unit comprises a pressure regulator, in particular a closed-loop pressure control valve, a switch-on valve, a pressure build-up valve, a pressurized fluid filter, a pressurized fluid dryer, water separators and/or a pressurized fluid oiler.

The invention further relates to a fluidic system comprising a pressurized fluid source, the maintenance assembly and a fluidic consumer, in particular a fluidic machine, which is fluidically connected to the pressurized fluid source via the maintenance assembly, so that pressurized fluid required for operating the fluidic consumer can be supplied from the pressurized fluid source to the fluidic consumer via the maintenance assembly.

The invention further relates to a method for operating the industrial sensor module, the maintenance assembly or the fluidic system, comprising the steps of: detecting the pressurized fluid flow and generating the diagnostic information. Optionally, in the method, the pressure, the temperature and/or variables that can be derived therefrom, such as volume or flow velocity, are detected.

### BRIEF DESCRIPTION OF THE DRAWINGS

Further exemplary details and exemplary embodiments are explained below with reference to the figures. Thereby shows

FIG. 1 a schematic representation of a fluidic system and

FIG. 2 a schematic representation of an industrial sensor module.

### DETAILED DESCRIPTION OF THE INVENTION

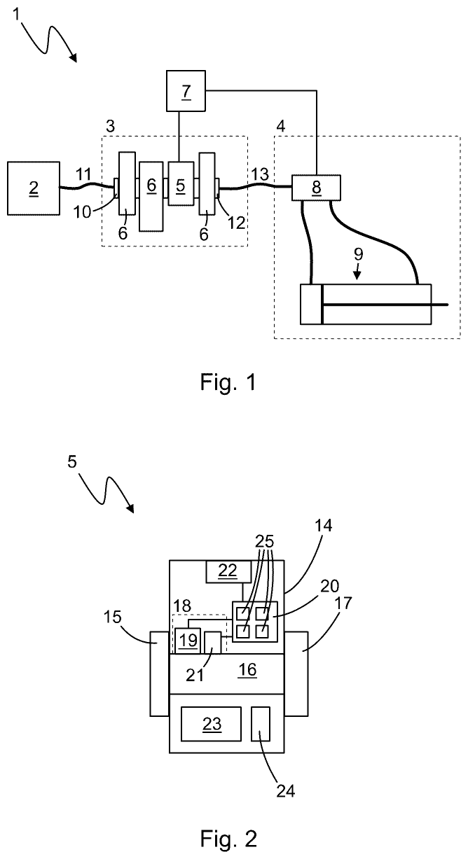

FIG. 1 shows a fluidic system 1. The fluidic system 1 is in particular an industrial fluidic system, for example a fluidic system for industrial automation. The fluidic system 1 expediently comprises a pressurized fluid source 2, a maintenance assembly 3 and/or a fluidic consumer 4. The fluidic consumer 4 is, for example, a fluidic machine, in particular a pneumatic machine. The fluidic consumer 4 is fluidically connected to the pressurized fluid source 2 via the maintenance assembly 3, so that pressurized fluid required for the operation of the fluidic consumer 4 can be (and preferably is) supplied from the pressurized fluid source 2 to the fluidic consumer 4 via the maintenance assembly 3.

The maintenance assembly 3 can preferably also be provided on its own—i.e. in particular without the other components of the fluidic system 1. The maintenance assembly 3 is used for the pressurized fluid treatment of the fluidic system 1, in particular for the treatment of the supply pressurized fluid of the fluidic system 1. The maintenance assembly 3 comprises, by way of example, a fluidic inlet 10, for example a hose connection, via which the maintenance assembly 3 is connected (in particular via a first hose 11) to the pressurized fluid source 2 and/or a fluidic outlet 12, for example a hose connection, via which the fluidic consumer 4 is connected (in particular via a second hose 13) to the maintenance assembly 3. The maintenance assembly 3 comprises an industrial sensor module 5 and preferably at least one functional unit 6 fluidically connected to the industrial sensor module 5. Exemplarily, several functional units 6 are present. Expediently, one or more functional units are fluidically connected upstream of the industrial sensor module 5 (in the direction of the pressurized fluid flow from the pressurized fluid source 2 to the fluidic consumer 4). Expediently, the functional units 6 and the industrial sensor module 5 are fluidically connected in series. The at least one functional unit 6 expediently comprises a pressure regulator, in particular a pressure control valve, a switch-on valve, a pressure build-up valve, a pressurized fluid filter, a pressurized fluid dryer and/or a pressurized fluid oiler. In particular, the maintenance assembly 3 comprises (as functional units 6), a pressure regulator valve, a switch-on valve, a pressure build-up valve, a pressurized fluid filter, a pressurized fluid dryer and/or a pressurized fluid oiler.

Optionally, the fluidic system 1 comprises several industrial sensor modules, each of which is designed in particular like the industrial sensor module 5. The multiple industrial sensor modules are expediently arranged at different locations in the fluidic system 1 and are preferably networked with one another, in particular communicatively connected.

Optionally, the fluidic system 1 comprises a control device 7, which comprises, for example, a higher-level controller, in particular a PLC (programmable logic controller). The control device 7 is in particular an external control device. The control device 7 is used, for example, to control and/or diagnose the fluidic system, in particular the maintenance assembly 3 and/or the fluidic consumer 4. Optionally, the control device 7 can be designed as a cloud server or comprise a cloud server. Furthermore, the control device 7 can be designed as a mobile device (for example a smartphone or tablet computer) or comprise a mobile device. Furthermore, the control device 7 can comprise a communication unit, for example an I/O link master, which is communicatively connected to the maintenance assembly 3, in particular the industrial sensor module 5.

By way of example, the fluidic consumer 4 comprises a valve device 8 and/or a fluidic actuator 9. By way of example, the fluidic actuator 9 is supplied with the pressurized fluid provided by the pressurized fluid source 2 (and routed via the maintenance assembly 3) via the valve device 8. By way of example, the fluidic actuator 9 comprises a fluidic drive cylinder.

FIG. 2 shows an exemplary configuration of the industrial sensor module 5. The industrial sensor module 5 can be provided on its own—i.e. in particular without the other components of the maintenance assembly 3 and/or the fluidic system 1. Optionally, the industrial sensor module 5 can in itself represent the maintenance assembly 3—i.e. in particular be connected fluidically between the pressurized fluid source 2 and the fluidic consumer 4.

The industrial sensor module 5 is intended in particular for use in the maintenance assembly 3 (which is used for the pressurized fluid treatment of the fluidic system 1). The industrial sensor module 5 comprises a module housing 14, which is in particular the outer housing of the industrial sensor module 5. The industrial sensor module 5 comprises a pressurized fluid inlet 15 arranged (in particular on the module housing 14), which is designed, for example, as a hose connection. The industrial sensor module 5 further comprises a pressurized fluid channel 16 arranged in the module housing 14. As an example, the pressurized fluid channel 16 extends transversely through the module housing 14. For example, the pressurized fluid channel 16 extends from a first side of the module housing 14 to a second side (arranged opposite to the first side) of the module housing 14. The industrial sensor module 5 further comprises a pressurized fluid outlet 17 (in particular fluidically connected to the pressurized fluid inlet 15 via the pressurized fluid channel 16), preferably arranged on the module housing 14, wherein the pressurized fluid outlet 17 is designed, for example, as a hose connection.

The industrial sensor module 5 is expediently a pure sensor module. In particular, the industrial sensor module 5 does not comprise a valve, an actuator and/or an electrofluidic transducer. The industrial sensor module 5 expediently has no control function.

Optionally, the industrial sensor module can have a flow channel switchover for adjusting a measuring range and, in particular, an associated control function.

Exemplarily, the industrial sensor module 5 is connected with its pressurized fluid inlet 15 to a first functional unit 6 of the maintenance assembly 3 and/or is connected with its pressurized fluid outlet 17 to a second functional unit 6 of the maintenance assembly 3. Pressurized fluid from the pressurized fluid source flows exemplarily into the pressurized fluid inlet 15 (after expediently) passing through one or more functional units 6 upstream of the industrial sensor module 5, through the pressurized fluid channel 16, and out of the pressurized fluid outlet 17 to the fluidic consumer 4 (optionally via one or more functional units 6 downstream of the industrial sensor module 5).

The industrial sensor module 5 comprises a sensor device 18 (in particular arranged in the module housing 14) with a flow sensor 19. The flow sensor 19 expediently serves to detect a pressurized fluid flow from the pressurized fluid inlet 15 to the pressurized fluid outlet 17, in order to provide one or more flow values. The one or more flow values represent the detected flow. For example, the one or more flow values are generated using a computing unit 20, for example by transmitting (in particular electrical) flow signals representing the detected flow from the flow sensor 19 to the computing unit 20 and the computing unit 20 generates, in particular calculates, the one or more flow values based on the flow signals. Optionally, the computing unit 20 is designed to calculate one or more variables derived from the detected flow, for example a volume.

The industrial sensor module 5 comprises the computing unit 20 (in particular arranged in the module housing 14), which is designed, for example, as a microcontroller.

Optionally, the sensor device 18 further comprises a pressure sensor 21 for sensing a pressurized fluid pressure of pressurized fluid present in the pressurized fluid channel 16 to provide one or more pressure values. For example, the one or more pressure values are generated using the computing unit 20, for example by transmitting (in particular electrical) pressure signals representing the detected pressure from the pressure sensor 21 to the computing unit 20 and the computing unit 20 generates, in particular calculates, the one or more pressure values based on the pressure signals.

Optionally, the sensor device 18 comprises a temperature sensor.

Preferably, the industrial sensor module 5 comprises a digital communication interface 22 (in particular arranged on the module housing 14), which is designed, for example, as an I/O link communication interface and expediently serves to output diagnostic information. The digital communication interface 22 is in particular a digital bidirectional communication interface. Preferably, at least one diagnostic function of the industrial sensor module 5 can be configured via the digital communication interface 22. As an example, the industrial sensor module 5 is connected to the control device 7 via the digital communication interface 22.

Expediently, the industrial sensor module 5 comprises a display 23, for example a graphical display, and/or an operating device 24. For example, the industrial sensor module 5 displays one or more flow values and/or pressure values and/or the diagnostic information via the display 23. A user can make a user input via the operating device 24.

Preferably, the computing unit 20 is configured to provide a diagnostic function for generating the diagnostic information on the basis of the one or more flow values and optionally taking pressure and/or temperature into account. The diagnostic function is implemented as software, for example, and is executed in particular on the computing unit 20, which is designed as a microcontroller.

The diagnostic function is directed in particular at the fluidic consumer 4, preferably at the part of the fluidic consumer 4 that is supplied with pressurized fluid via the industrial sensor module 5. For example, the diagnostic function is used to monitor the performance of the fluidic consumer 4. Furthermore, the diagnostic function is preferably directed at a part of the fluidic system 1 upstream of the industrial sensor module 5.

For example, the diagnostic function may include one or more of the following procedures or functions: an operating state discrimination function, one or more operating state counters, a flow monitoring procedure, a pressure drop monitoring procedure, a pressure supply stability monitoring procedure, a power sensing procedure, and/or a cycle counting procedure.

The various possible functions and procedures of the diagnostic function are described in more detail below.

First of all, the operating state discrimination function:

Preferably, the at least one diagnostic function comprises the operating state discrimination function. The computing unit 20 is preferably designed (in particular as part of the operating state discrimination function) to recognize a (in particular current) system operating state of the fluidic system from several possible system operating states on the basis of the detected pressurized fluid flow (and optionally taking into account one or more variables derived from the flow, such as volume) and to take the recognized system operating state into account when providing the diagnostic function and/or generating the diagnostic information.

The plurality of possible system operating states relate in particular to the fluidic consumer 4. Expediently, the plurality of possible system operating states are defined in the computing unit 20. The computing unit 20 is expediently capable of recognizing each of the plurality of possible system operating states (in case the respective operating state is given). The plurality of possible system operating states expediently comprise at least two, at least three or at least four (different) system operating states. Purely by way of example, the possible system operating states comprise exactly four different system operating states. Expediently, the industrial sensor module 5 is designed to always assume the presence of one of the system operating states.

Preferably, the computing unit 20 generates operating state information according to the detected system operating state, wherein the operating state information indicates the detected system operating state. Optionally, the industrial sensor module 5 provides the operating state information as part of the diagnostic information. For example, the industrial sensor module 5 outputs the detected system operating state via the digital communication interface 22, for example as 4-bit information and/or cyclically or on request.

Preferably, the computing unit 20 is configured to recognize the system operating state (in particular as part of the operating state discrimination function), taking into account the detected pressurized fluid pressure. In particular, the operating state discrimination function maps the flow values and/or the pressure values to the several possible system operating states.

Preferably, the computing unit 20 is configured to use flow values and/or pressure values for generating the diagnostic information depending on which system operating state the flow values and/or pressure values are associated with. By the formulation that (one or more) flow values are associated with a system operating state, it is meant in particular that the pressurized fluid flow on which the (one or more) flow values are based was recorded during this system operating state. The formulation that (one or more) pressure values are associated with a system operating state means in particular that the pressurized fluid pressure (underlying the one or more) pressure values was detected during this system operating state.

In particular, the computing unit 20 is configured to select flow values and/or pressure values to be taken into account for generating the diagnostic information depending on the detected system operating state during which the flow values and/or pressure values were detected. For example, the computing unit 20 is configured to use the operating state discrimination function to specifically take into account, for the generation of the diagnostic information, flow values and/or pressure values that were provided during a first system operating state and/or to specifically not take into account flow values and/or pressure values that were provided during a second system operating state.

For example, the possible system operating states include a depressurized operating state, a passive operating state and/or at least one active operating state, in particular an active-static operating state and/or an active-dynamic operating state.

In the depressurized operating state, the detected pressurized fluid pressure (in particular a pressure value) is below a pressure threshold value (in particular defined in the computing unit 20). The depressurized operating state is present in particular when no pressurized fluid is present in the pressurized fluid channel 16 of the industrial sensor module 5 (this means in particular that no pressurized fluid from the pressurized fluid source 2 is present at the fluidic consumer 4). In particular, the depressurized operating state indicates that the fluidic machine 4 is not ready for operation (in particular because it lacks the pressurized fluid required for operation). The computing unit 20 is designed to recognize the depressurized operating state in response to the fact that the pressurized fluid pressure detected is less than the pressure threshold value. Preferably, the computing unit 20 is configured to provide diagnostic information indicating the depressurized operating state in response to a detection of the depressurized operating state. Optionally, the industrial sensor module 5 assumes that the depressurized operating state is present immediately after the industrial sensor module 5 is switched on.

Preferably, the computing unit 20 is configured to form (in particular continuously) a pressure average value of the detected pressurized fluid pressure (for example of the pressurized fluid values) in order to detect the current system operating state, and to compare the pressure average value with the pressure threshold value, and/or to form (in particular continuously) a flow average value of the detected pressurized fluid flow (for example of the flow values), and to compare the flow average value with a flow threshold value. Expediently, the computing unit 20 uses a predetermined filter constant to form the pressure average value and/or the flow average value.

Optionally, a reference pressure is determined, stored and filtered for at least one flow value.

In the passive operating state, the detected pressurized fluid pressure (in particular a pressure value) is above a/the pressure threshold value (in particular defined in the computing unit 20) and/or the detected pressurized fluid flow (in particular a flow value) is below a flow threshold value (in particular defined in the computing unit 20). The passive operating state is present in particular when pressurized fluid is present in the pressurized fluid channel 16 and there is no pressurized fluid flow (in particular no flow greater than a minimum flow) through the pressurized fluid channel 16. In particular, this means that pressurized fluid from the pressurized fluid source 2 is present at the fluidic consumer 4—i.e. that the fluidic consumer 4 is ready for operation—but that there is no active operation—and thus no pressurized fluid consumption (in particular based on an active operation of the fluidic consumer 4)—of the fluidic consumer 4. The passive operating state therefore indicates in particular that the fluidic consumer 4 is ready for operation but not actively in operation. The computing unit 20 is configured to recognize the passive operating state in response to the fact that the detected pressurized fluid pressure is greater than the pressure threshold value and/or the detected pressurized fluid flow is less than the flow threshold value. Preferably, the computing unit 20 is configured to provide diagnostic information indicating the passive operating state in response to a detection of the passive operating state.

In the active operating state, the detected pressurized fluid pressure (in particular a pressure value) is above a/the pressure threshold value (in particular defined in the computing unit 20) and/or the detected pressurized fluid flow (in particular a flow value) is above a/the flow threshold value (in particular defined in the computing unit 20). The active operating state is present in particular when pressurized fluid is present in the pressurized fluid channel 16 and/or a pressurized fluid flow (in particular a flow greater than a minimum flow) is present through the pressurized fluid channel 16. This means in particular that pressurized fluid from the pressurized fluid source 2 is present at the fluidic consumer 4—i.e. that the fluidic consumer 4 is ready for operation-and that there is active operation—and thus pressurized fluid consumption—of the fluidic consumer 4. The active operating state therefore indicates in particular that the fluidic consumer 4 is ready for operation and active in operation. The computing unit 20 is designed to recognize the active operating state in response to the fact that the detected pressurized fluid pressure is greater than the pressure threshold value and/or the detected pressurized fluid flow is greater than the flow threshold value. Preferably, the computing unit 20 is designed to provide diagnostic information indicating the active operating state in response to a detection of the active operating state.

Preferably, the at least one active operating state comprises an active-static operating state, in which a static pressurized fluid flow is present, and/or an active-dynamic operating state, in which a dynamic pressurized fluid flow is present. The computing unit 20 is preferably designed to distinguish between these two active operating states. In the active-static operating state, the pressurized fluid flow through the pressurized fluid channel 16 is constant, for example, or the changes in the pressurized fluid flow remain within a tolerance band defined in the computing unit 20. In the active-dynamic operating state, the changes in the pressurized fluid flow through the pressurized fluid channel 16 are greater than in the active-static operating state and are preferably (also) outside the tolerance band. Preferably, the computing unit 20 is designed to distinguish between the active-static operating state and the active-dynamic operating state by means of a max-min evaluation of the flow values (in particular carried out at fixed intervals, for example of one second). For example, the computing unit recognizes a maximum flow value (of the flow values recorded in this interval) and a minimum flow value (of the flow values recorded in this interval) in each interval and uses a difference between the maximum flow value and the minimum flow value to determine whether the active-static operating state or the active-dynamic operating state is present, in particular on the basis of a comparison of this difference with a threshold value.

The active-static operating state is present, for example, when the fluidic consumer 4 is in a static state, for example in a blocking state, and requires a constant supply of pressurized fluid, for example blocking air (in German: “Sperrluft”), for this purpose. Furthermore, the active-static operating state can be an undesirable state in which pressurized fluid is consumed unnecessarily, in particular in the case of a stationary fluidic consumer 4. Optionally, the industrial sensor module 5, in particular the computing unit 20, is designed to output a warning in response to the detected active-static operating state. Optionally, a delay time is defined in the computing unit 20, for example several seconds, and the computing unit 20 outputs the warning (or a message) relating to the active-static operating state in response to the fact that the active-static operating state has been detected over the delay time.

Preferably, the industrial sensor module 5, in particular the computing unit 20, comprises a plurality of operating state counters 25. Preferably, each operating state counter 25 is implemented as software and is expediently executed on the computing unit 20, in particular as part of the diagnostic function. Expediently, each operating state counter 25 is associated with a respective system operating state. Preferably, each operating state counter 25 records a respective operating state time duration, which describes how long the industrial sensor module 5 has been in the respective operating state. Preferably, at least two, at least three or at least four operating state counters 25 are present. In particular, there are exactly four operating state counters 25. By way of example, the industrial sensor module 5 comprises an depressurized operating state counter, which records the hitherto duration of the depressurized operating state, and/or a passive operating state counter, which records the hitherto duration of the passive operating state, and/or an active-static operating state counter, which records the hitherto duration of the active-static operating state, and/or an active-dynamic operating state counter, which records the hitherto duration of the active-dynamic operating state. Expediently, each operating state counter 25 is configured to cyclically count the presence of the respectively associated operating state, in particular in the unit “operating hours”, for example with a resolution of 0.01 operating hours. Expediently, the computing unit 20 is designed to write the operating state duration recorded by each operating state counter 25 to a non-volatile memory. Expediently, the sum of all operating state counters 25 results in the operating time of the industrial sensor module 5 and/or the fluidic consumer 4. As an example, the computing unit 20 provides one or more of the operating state durations as part of the diagnostic information.

The flow monitoring procedure is described below:

Preferably, the diagnostic function comprises the flow monitoring procedure for monitoring the flow of pressurized fluid (by the sensor module 5). The flow monitoring procedure is particularly aimed at monitoring the consumption of pressurized fluid by the fluidic consumer 4. For example, an increasing pressurized fluid consumption may be judged as an indication of leakage, optionally by the industrial sensor module 5 and/or the control device 7. In particular, an increase in an average pressurized fluid flow, in particular above a predetermined threshold, may be judged as an indication of leakage, optionally by the industrial sensor module 5 and/or the control device 7. Furthermore, a change in the flow, in particular a peak flow, can be assessed as an indication of an undesired change in a setting of the fluidic consumer 4, of leakage (in particular with an increasing peak flow) and/or of contamination and/or of a pressure drop (in particular with a decreasing peak flow), optionally by the industrial sensor module 5 and/or the control device 7.

Preferably, the computing unit 20 is designed to generate flow monitoring information as part of the flow monitoring procedure on the basis of flow values (in particular those recorded by the flow sensor 19). The flow monitoring information is part of the diagnostic information, for example. The flow monitoring information includes, for example, a warning.

The possible system operating states include a predetermined operating state, in particular an active operating state. In the active operating state, the detected pressurized fluid flow is expediently above a flow threshold value.

The computing unit 20 is preferably configured to use flow values for generating the flow monitoring information in response to the fact that the flow values are associated with a predetermined operating state, in particular the active operating state. Preferably, the computing unit 20 is configured to take flow values into account for the flow monitoring procedure in response to the fact that the flow values were recorded during the active operating state. Preferably, the computing unit 20 only takes into account, for the flow monitoring procedure, flow values that were recorded during the active operating state, in particular the active-dynamic operating state. Optionally, a flag in the computing unit 20 can be used to configure whether flow values that were recorded during the active-static operating state are also to be taken into account for the flow monitoring procedure.

Optionally, the computing unit 20 has one, two or three operating modes that can be set for the flow monitoring procedure, for example via one or more configuration flags.

For example, the computing unit 20 has a first operating mode in which the computing unit 20 uses only flow values captured during the active-dynamic operating state to generate the flow monitoring information.

For example, the computing unit 20 has a second operating mode in which the computing unit 20 uses only flow values detected during the active-static operating state or during the active-dynamic operating state to generate the flow monitoring information.

For example, the computing unit 20 has a third operating mode in which the computing unit 20 uses only flow values detected during the active-static operating state or during the active-dynamic operating state or during the passive operating state to generate the flow monitoring information.

Preferably, the computing unit 20 is configured to use, in response to the presence of an enable signal from the external control device 7, flow values for generating the flow monitoring information and/or to generate, in response to the presence of the enable signal, the flow monitoring information.

Optionally, the computing unit 20 is configured to select one or more flow values for generating the flow monitoring information in accordance with an enable signal provided by the control device 7. The enable signal indicates, for example, the flow values to be used for generating the flow monitoring information and/or indicates one or more times that are associated with the flow values to be used, in particular times at which the flow values to be used are recorded.

As an example, the computing unit 20 has a pause/resume function with respect to collecting flow values for generating the flow monitoring information. For example, the pause/resume function can be used to pause and/or resume the collection of the flow values for generating the flow monitoring information, in particular in response to a signal from the control device 7, for example in response to the enable signal. For example, providing the enable signal causes the collection of the flow values for generating the flow monitoring information to be continued and/or not providing the enable signal (and/or providing a pause signal) causes the collection of the flow values for generating the flow monitoring information to be paused.

In particular, if the enable signal is not present, no difference is formed at the end of a diagnostic record.

Preferably, the computing unit 20 is designed to generate, in particular calculate, and/or output the flow monitoring information, for example a warning, on the basis of a flow reference value and a flow monitoring value. For example, the computing unit 20 calculates a difference between the flow reference value and the flow monitoring value (in particular determined in a current diagnostic period) and compares the difference with a threshold value and provides the flow monitoring information, in particular the warning, on the basis of the comparison. The flow reference value is recorded, for example, during the first execution of the flow monitoring procedure, in particular during commissioning of the sensor module 5 and/or the fluidic consumer 4. The flow monitoring value expediently describes a current pressurized fluid flow of the sensor module 5 and is expediently determined by the computing unit 20 on the basis of currently recorded flow values, in particular on the basis of the last recorded flow values. Expediently, as part of the flow monitoring procedure, the computing unit 20 continuously calculates a new flow monitoring value on the basis of currently detected flow values and compares the latest flow monitoring value with the flow reference value in order to generate the flow monitoring information.

Preferably, the flow reference value and/or the flow monitoring value is a respective average value of the pressurized fluid flow over the diagnostic period. The diagnostic period is expediently specified via a parameter and preferably comprises several operating cycles of the fluidic consumer 4, for example at least 10 or at least 20 operating cycles.

Preferably, the computing unit 20 is configured to repeatedly perform the flow monitoring procedure, wherein the computing unit 20 performs each flow monitoring procedure for a respective diagnostic period. For each execution of the flow monitoring procedure, the computing unit 20 calculates a respective flow monitoring value (in particular as a respective average value) on the basis of (in particular only) the flow values recorded in the respective diagnostic period, which are associated with one or more predetermined operating states (in particular the active-dynamic state), as explained in particular above. The flow values recorded in a diagnostic period are expediently stored by the computing unit 20 in a respective diagnostic data record, which may also be referred to as a diagnostic record.

Preferably, the computing unit 20 is designed to calculate the flow reference value on the basis of flow values from a (in particular initial) reference diagnostic period. The reference diagnostic period expediently corresponds to the aforementioned diagnostic periods, in particular with regard to its length. In particular, the reference diagnostic period is the same length as one or each of the diagnostic periods and/or comprises the same number of operating cycles of the fluidic consumer 4 as one or each of the diagnostic periods. Preferably, the computing unit 20 selects the flow values to be used for the calculation of the flow reference value in the same way as the flow values to be used for the calculation of the respective flow monitoring value, in particular based on the respective associated operating state. Expediently, the computing unit 20 calculates the flow reference value (in particular as an average value) on the basis of (in particular only) those flow values recorded in the reference diagnostic period, which flow values are associated with one or more predetermined operating states (in particular the active-dynamic state).

In this way, it is possible in particular to ensure that flow values that are present during operating pauses of the fluidic consumer 4 and could possibly falsify the diagnosis are not included in the calculation of the flow monitoring value and/or the flow reference value.

Optionally, the flow reference value is linked to a pressure value present at the time the flow reference value is determined.

Preferably, the possible system operating states include the active operating state, in which the detected pressurized fluid flow is above a flow threshold value. The diagnostic function comprises the flow monitoring procedure for monitoring the pressurized fluid flow. The computing unit 20 is configured to generate flow monitoring information based on flow values as part of the flow monitoring procedure. The computing unit 20 is configured to use flow values, depending on the fact that the flow values are associated with the active operating state, for generating the flow monitoring information. Preferably, the computing unit 20 is configured to generate the flow monitoring information based on a difference between a flow monitoring value and a flow reference value. The computing unit 20 is configured to calculate the flow monitoring value on the basis of flow values recorded in the current diagnostic period that are associated with the active operating state, and to calculate the flow reference value on the basis of flow values recorded in the reference diagnostic period that are associated with the active operating state.

Optionally, the computing unit 20 is configured to generate the flow monitoring information as part of the flow monitoring procedure on the basis of a flow reference peak value and a current flow peak value, for example by comparing the flow reference peak value and the current flow peak value. The flow reference peak value is a peak value of the detected pressurized fluid flow and is detected, for example, during the first execution of the flow monitoring procedure, in particular during commissioning of the sensor module 5 and/or the fluidic consumer 4. The current peak flow value is expediently a peak value of a currently detected pressurized fluid flow of the sensor module 5 and is expediently determined by the computing unit 20 on the basis of currently detected flow values, in particular on the basis of the most recently detected flow values.

Optionally, there are different program sequences for different work processes to be carried out with the fluidic consumer 4. For example, the different program sequences are defined in the control device 7. Optionally, the industrial sensor module 5 determines a separate flow reference value and/or separate flow monitoring value and/or performs a separate flow monitoring procedure for each program sequence, in particular based on the control device 7 informing the industrial sensor module 5 which program sequence is currently being performed.

The pressure drop monitoring procedure is described below:

Preferably, the diagnostic function comprises the pressure drop monitoring procedure for monitoring a pressure drop that occurs in a part of the fluidic system upstream of the sensor module. As part of the pressure drop monitoring procedure, the computing unit 20 is designed to generate pressure drop monitoring information on the basis of pressure values (in particular detected by means of the pressure sensor 21). The pressure drop monitoring information is, for example, part of the diagnostic information.

The upstream part of the fluidic system 1 is, for example, the part of the fluidic system 1 fluidically connected between the pressurized fluid source 2 and the industrial sensor module 5, in particular in an embodiment in which no pressure regulator is connected between the pressurized fluid source 2 and the industrial sensor module 5. As an example, the upstream part comprises the first hose 11, one or more functional units 6 connected upstream of the industrial sensor module 5, for example a switch-on valve, and/or one or more hose connections, for example push-in fittings.

Optionally, a pressure regulator is connected between the pressurized fluid source 2 and the industrial sensor module 5. For example, a functional unit 6 connected upstream of the industrial sensor module 5 is a pressure regulator. In this case in particular, the upstream part of the fluidic system 1 is the part of the fluidic system 1, in particular of the maintenance assembly 3, that is fluidically connected between the pressure regulator and the industrial sensor module 5. As an example, the upstream part comprises one or more functional units 6, in particular a pressurized fluid filter, of the maintenance assembly 3 that are fluidically connected between the pressure regulator and the industrial sensor module 5. The pressure regulator is in particular a closed-loop pressure controller.

The computing unit 20 is configured to use pressure values (in particular those recorded by the pressure sensor 21) for generating the pressure drop monitoring information, depending on the system operating state with which the pressure values are associated. In particular, the computing unit 20 is configured to take pressure values into account in order to determine a reference value for the pressure drop monitoring procedure, in response to the fact that those pressure values were recorded during the passive operating state.

The computing unit 20 is expediently configured to calculate, as part of the pressure drop monitoring procedure, a pressure drop value on the basis of, in particular as a difference between, a pressure value associated with the passive operating state (which is also to be referred to below as the supply pressure value) and a pressure value associated with the active operating state (which is also to be referred to below as the sensor module pressure value) and to generate the pressure drop monitoring information on the basis of the pressure drop value. The pressure drop value describes the pressure drop in the upstream part.

Preferably, the computing unit 20 determines the supply pressure value based on a pressurized fluid pressure detected in the passive operating state, for example on the basis of one or more pressurized fluid pressure values detected (by means of the pressure sensor 21) in the passive operating state. Since in the passive operating state the pressurized fluid flow through the upstream part is very small or equal to zero, little or no pressurized fluid pressure drops across the upstream part in this state, so that the one or more pressure values detected by the industrial sensor module 5 in the passive operating state is close to or equal to the pressurized fluid pressure upstream of the upstream part, i.e. in particular the pressurized fluid pressure at the pressurized fluid source 2 or the pressurized fluid pressure at the pressure regulator. Consequently, on the basis of one or more pressurized fluid pressure values detected in the passive operating state (by means of the pressure sensor 21), the computing unit 20 can determine the supply pressure value (for example as an average value of the multiple pressurized fluid pressure values), which represents the pressurized fluid pressure upstream of the upstream part. Preferably, the computing unit 20 uses only pressurized fluid pressure values that were recorded in the passive operating state to calculate the supply pressure value.

Preferably, the computing unit 20 determines the sensor module pressure value based on a pressurized fluid pressure detected in the active operating state, in particular in the active-static operating state and/or in the active-dynamic operating state, for example on the basis of one or more pressurized fluid pressures detected (by means of the pressure sensor 21) in the active operating state. Preferably, the computing unit 20 uses only pressurized fluid pressure values recorded in the active operating state to calculate the sensor module pressure value.

Preferably, the pressure drop monitoring information comprises a pressure drop warning. As an example, the industrial sensor module 5, in particular the computing unit 20, is configured to output the pressure drop monitoring information, in particular the pressure drop warning, on the basis of the pressure drop value, for example via the digital communication interface 22 and/or the display 23. In particular, the industrial sensor module 5 is configured to determine a change in the pressure drop across the upstream part on the basis of the pressure drop value and to output the pressure drop monitoring information, in particular the pressure drop warning, in accordance with this determination.

Preferably, the computing unit 20 calculates a reference pressure drop value, in particular a first reference pressure drop value and/or a second reference pressure drop value, for example during a commissioning of the industrial sensor module 5 and/or during a first execution of the pressure drop monitoring procedure, and further continuously calculates a current monitoring pressure drop value, in particular a first monitoring pressure drop value and/or a second monitoring pressure drop value. Preferably, the computing unit 20 determines the change in the pressure drop on the basis of a comparison of the reference pressure drop value with the current monitoring pressure drop value, in particular on the basis of a first comparison of the first reference pressure drop value with the first current monitoring pressure drop value and/or a second comparison of the second reference pressure drop value with the second current monitoring pressure drop value. The first reference pressure drop value and the first current monitoring pressure drop value expediently each relate to a pressure drop for an average pressurized fluid flow. The second reference pressure drop value and the second current monitoring pressure drop value expediently each relate to a pressure drop for a peak pressurized fluid flow.

Preferably, the computing unit 20 calculates the reference pressure drop value as the difference between a reference supply pressure value based on a pressurized fluid pressure detected by the pressure sensor 21 in the passive operating state and a reference sensor module pressure value based on a pressurized fluid pressure detected by the pressure sensor 21 in the active operating state. In this way, expediently, the first reference pressure drop value and the second reference pressure drop value are calculated, wherein for the first reference pressure drop value, the pressurized fluid pressure detected in the active operating state is detected at an average pressurized fluid flow (which is defined, for example, as a first tolerance band in the computing unit 20) and/or for the second reference pressure drop value, the pressurized fluid pressure detected in the active operating state is detected at a peak pressurized fluid flow (which is defined, for example, as a second tolerance band in the computing unit 20).

Expediently, the computing unit 20 calculates the monitoring pressure drop value as a difference between a monitoring supply pressure value based on a pressurized fluid pressure detected by the pressure sensor 21 in the passive operating state and a monitoring sensor module pressure value based on a pressurized fluid pressure detected by the pressure sensor 21 in the active operating state. In this way, expediently, the first monitoring pressure drop value and the second monitoring pressure drop value are calculated, wherein for the first monitoring pressure drop value, the pressurized fluid pressure detected in the active operating state is detected at an average pressurized fluid flow (which is defined, for example, as a first tolerance band in the computing unit 20) and/or for the second monitoring pressure drop value, the pressurized fluid pressure detected in the active operating state is detected at a peak pressurized fluid flow (which is defined, for example, as a second tolerance band in the computing unit 20).

The pressure supply stability monitoring procedure is explained below.

Preferably, the diagnostic function comprises a pressure supply stability monitoring procedure for monitoring a stability of a pressurized fluid supply. The computing unit 20 is expediently configured to generate, as part of the pressure supply stability monitoring procedure, pressure supply stability monitoring information which expediently indicates how stable the pressurized fluid supply of the industrial sensor module 5 and/or the fluidic consumer 4 is. The pressure supply stability monitoring procedure is particularly aimed at detecting dynamic disturbances in the pressurized fluid supply, for example caused by neighboring system parts.

The computing unit 20 is preferably configured to use, for generating the pressure supply stability monitoring information, pressure values in response to those pressure values being associated with the passive operating state. In particular, the computing unit 20 is configured to take into account pressure values for generating the pressure supply stability information in response to the fact that those pressure values were detected during the passive operating state. Preferably, the computing unit 20 only takes into account pressure values that were recorded during the passive operating state to generate the pressure supply stability information. The pressure values are pressure values recorded with the pressure sensor 21.

Optionally, the computing unit 20 can be configured to take pressure values into account for the generation of the pressure supply stability information in response to the fact that the pressure values were recorded at a predetermined flow value, for example in the active operating state. For example, the condition for the computing unit 20 to take a pressure value into account for the generation of the pressure supply stability information is that the flow present when the pressure value is detected is equal to a predetermined value and/or is within a tolerance band around a predetermined value (in particular greater than zero).

Expediently, the computing unit performs a statistical evaluation and/or extreme value monitoring of the pressure values recorded in the passive operating state and generates the pressure supply stability information on the basis of the statistical evaluation and/or the extreme value monitoring, for example by evaluating an average deviation from an average value of the pressure values.

Optionally, the computing unit 20 performs a power detection procedure, in particular for detecting and outputting fluid power and energy. For example, the computing unit 20 for the power detection procedure comprises a min/max memory and an average function. Preferably, the computing unit 20 integrates the energy.

Optionally, the computing unit 20 performs a switching cycle counting procedure to provide a switching cycle count for all switching outputs (for example, flow, pressure and temperature). Expediently, the computing unit 20 monitors range overruns and/or range underruns for all ranges, in particular measurement ranges, for example for flow, pressure, temperature, power and/or supply voltage. Expediently, the computing unit 20 has parameterizable thresholds for the counters.

Optionally, the computing unit 20 has a counter for counting a number of volume pulses, a counter for counting a number of active-static messages, a counter for counting switching cycles during a leakage detection, a counter for counting switching cycles during a pressure drop at a medium flow, a counter for counting switching cycles during a pressure drop at a peak flow and/or a counter for counting short-circuit detections.

1. An industrial sensor module comprising:
a module housing,
a pressurized fluid inlet arranged on the module housing,
a pressurized fluid channel arranged in the module housing and a pressurized fluid outlet arranged on the module housing and fluidically connected to the pressurized fluid inlet via the pressurized fluid channel,
as well as a sensor device arranged in the module housing with a flow sensor for detecting a pressurized fluid flow from the pressurized fluid inlet to the pressurized fluid outlet in order to provide one or more flow values, and
wherein the sensor module further comprises a computing unit arranged in the module housing, wherein the computing unit is configured to provide at least one diagnostic function for generating diagnostic information on the basis of the one or more flow values.

2. The industrial sensor module of claim 1, wherein the industrial sensor module is for use in a maintenance assembly which serves for a treatment of pressurized fluid of a fluidic system.

3. The industrial sensor module according to claim 1, wherein the computing unit is configured to recognize, on the basis of the detected pressurized fluid flow, a system operating state of the fluidic system from among a plurality of possible system operating states, and to take the recognized system operating state into account when providing the diagnostic function and/or generating the diagnostic information.

4. The industrial sensor module according to claim 3, wherein the possible system operating states comprise a predetermined operating state, wherein the diagnostic function comprises a flow monitoring procedure for monitoring the pressurized fluid flow, and the computing unit is configured to generate, as part of the flow monitoring procedure, flow monitoring information based on flow values, the computing unit being configured to use flow values for generating the flow monitoring information depending on the flow values being associated with the predetermined operating state.

5. The industrial sensor module according to claim 4, wherein the predetermined operating state is an active operating state, in which the detected pressurized fluid flow is above a flow threshold value.

6. The industrial sensor module according to claim 4, wherein the computing unit is configured to generate the flow monitoring information on the basis of a difference between a flow monitoring value and a flow reference value, wherein the computing unit is configured to calculate the flow monitoring value on the basis of flow values detected in a current diagnostic period, and to calculate the flow reference value on the basis of flow values detected in a reference diagnostic period.

7. The industrial sensor module according to claim 4, wherein the computing unit is configured to use, in response to an enable signal from an external control device, flow values for the generation of the flow monitoring information and/or to generate, in response to the enable signal, the flow monitoring information.

8. The industrial sensor module according to claim 1, wherein the sensor device further comprises a pressure sensor for detecting a pressurized fluid pressure of pressurized fluid present in the pressurized fluid channel to provide one or more pressure values.

9. The industrial sensor module according to claim 8, wherein the computing unit is configured to recognize a system operating state taking into account the detected pressurized fluid pressure.

10. The industrial sensor module according to claim 3, wherein the computing unit is configured to use flow values and/or pressure values for generating the diagnostic information depending on which system operating state the flow values and/or pressure values are associated with.

11. The industrial sensor module according to claim 3, wherein the possible system operating states comprise a depressurized operating state in which the detected pressurized fluid pressure is below a pressure threshold and/or comprise a passive operating state, in which the detected pressurized fluid pressure is above the pressure threshold value and/or the detected pressurized fluid flow is below a flow threshold value, and/or at least one active operating state in which the detected pressurized fluid pressure is above the pressure threshold value and/or the detected pressurized fluid flow is above the flow threshold value.

12. The industrial sensor module according to claim 11, wherein the at least one active operating state comprises an active-static operating state in which a static pressurized fluid flow is present and/or an active-dynamic operating state in which a dynamic pressurized fluid flow is present.

13. The industrial sensor module according to claim 3, further comprising a plurality of operating state counters, wherein each operating state counter is associated with a respective system operating state and detects a respective operating state time duration describing how long the industrial sensor module has been in the respective operating state.

14. The industrial sensor module according to claim 8, wherein the diagnostic function comprises a pressure drop monitoring procedure for monitoring a pressure drop occurring in a part of the fluidic system upstream of the sensor module, wherein the computing unit is configured to generate, as part of the pressure drop monitoring procedure, pressure drop monitoring information based on pressure values and to use pressure values for generating the pressure drop monitoring information depending on which system operating state the pressure values are associated with.

15. The industrial sensor module according to claim 14, wherein the computing unit is configured to calculate, as part of the pressure drop monitoring procedure, a pressure drop value on the basis of a pressure value associated with the passive operating state and a pressure value associated with the active operating state and to generate the pressure drop monitoring information on the basis of the pressure drop value.

16. The industrial sensor module according to claim 11, wherein the diagnostic function comprises a pressure supply stability monitoring procedure for monitoring a stability of a pressurized fluid supply, and the computing unit is configured to generate, as part of the pressure supply stability monitoring procedure, pressure supply stability monitoring information, and to use pressure values for generating the pressure supply stability monitoring information depending on the fact that the pressure values are associated with the passive operating state.

17. The industrial sensor module according to claim 1, further comprising a digital communication interface arranged on the module housing for outputting the diagnostic information.

18. The industrial sensor module according to claim 17, wherein the digital communication interface is an I/O link communication interface,

19. A maintenance assembly for the pressurized fluid treatment of a fluidic system, the maintenance assembly comprising an industrial sensor module according to claim 1 and a functional unit fluidically connected to the industrial sensor module, wherein the functional unit comprises a pressure regulator, a switch-on valve, a pressure build-up valve, a pressurized fluid filter, a pressurized fluid dryer and/or a pressurized fluid oiler.

20. A fluidic system comprising a pressurized fluid source, a maintenance assembly according to claim 19 and a fluidic consumer which is fluidically connected to the pressurized fluid source via the maintenance assembly, so that pressurized fluid required for the operation of the fluidic consumer can be supplied from the pressurized fluid source to the fluidic consumer via the maintenance assembly.

21. A method of operating an industrial sensor module according to claim 1, comprising the steps of:
detecting the pressurized fluid flow and generating the diagnostic information.
